(19) United States
(12) Patent Application Publication
(10) Pub. No.: US 2025/0382161 A1
(43) Pub. Date: Dec. 18, 2025

(54) CART FOR TRANSPORTING AND POSITIONING TEMPORARY BRACES FOR USE DURING BUILDING CONSTRUCTION

(71) Applicant: Innovatech Systems, LLC, Kanarraville, UT (US)

(72) Inventors: James Barlow, Colorado City, AZ (US); James Harker, Colorado City, AZ (US)

(73) Assignee: Innovatech Systems, LLC, Kanarraville, UT (US)

(21) Appl. No.: 19/232,341

(22) Filed: Jun. 9, 2025

Related U.S. Application Data
(60) Provisional application No. 63/660,296, filed on Jun. 14, 2024.
(60) Provisional application No. 63/676,684, filed on Jul. 29, 2024.

(51) Int. Cl. B66C 23/42; B60P 1/54; B60P 3/40; B66C 23/70; E04G 25/02

(52) U.S. Cl. CPC B66C 23/42; B60P 1/549; B60P 3/40; B66C 23/70; E04G 25/02

(57) ABSTRACT

A temporary brace cart features a frame, a plurality of wheels for moving the frame, a bracket for coupling the frame to a vehicle (e.g., boom lift or other machine), a hoist extending vertically from the frame, a hoist arm extending from the hoist, and a winch coupled to the end of the hoist arm. In some uses, a plurality of temporary braces are positioned longitudinally along the frame for transport. A boom lift or other machine tows the cart to the desired location. Once at position, a cable may extend from the winch to a temporary brace. The winch may then be actuated so as to raise one end of the temporary brace, where it may be held until secured to the wall and ground by a worker.

### CROSS-REFERENCE TO RELATED APPLICATIONS

This application claims the benefit of U.S. Provisional App. Ser. No. 63/660,296 filed on Jun. 14, 2024, and further claims the benefit of U.S. Provisional App. Ser. No. 63/676,684 filed on Jul. 29, 2024, both of which are incorporated herein by reference.

### TECHNICAL FIELD

The present disclosure relates to building construction. More particularly, the present disclosure relates to a cart for transporting and positioning temporary wall braces.

### BACKGROUND

In modern commercial construction, large wall panels are frequently employed due to their structural benefits and efficiency in building design. These wall panels, typically fabricated off-site, are transported to the construction location where they are positioned and secured. To maintain the stability of these panels during the construction process, a plurality of temporary wall braces are utilized. These temporary braces play a crucial role in holding the panels in place until the panels are permanently secured as part of the building structure.

However, the use of temporary wall braces introduces several challenges. Given the substantial size and weight of the wall panels, the temporary braces themselves must be robust and sturdy, often resulting in braces that are extremely large and heavy. The cumbersome nature of these braces poses significant logistical difficulties on the jobsite. Maneuvering these heavy braces around the site can be a labor-intensive and time-consuming task. Typically, machinery such as boom lifts or cranes are required to lift and position the braces, yet even with such equipment, precise placement remains challenging.

The handling and positioning of these temporary wall braces also demand substantial manpower. A team of workers is often necessary to lift, align, and secure each brace in place. This not only slows down the construction process, but also increases labor costs. Furthermore, the physical exertion involved in manipulating these heavy braces heightens the risk of injuries among workers. Strains, sprains, and other musculoskeletal injuries can result in such scenarios, posing significant safety concerns.

In light of these issues, there is a clear need for an improved system and method that facilitates the transportation and positioning of temporary wall braces. Such a solution would aim to reduce the physical burden on workers, enhance safety, and streamline the construction process, ultimately leading to increased efficiency and reduced costs on the jobsite. The present disclosure seeks to solve these and other problems.

### SUMMARY OF EXAMPLE EMBODIMENTS

In some embodiments, a temporary brace cart comprises a frame, a plurality of wheels for moving the frame, a bracket for coupling the frame to a vehicle (e.g., boom lift or other machine), a hoist extending vertically from the frame, a hoist arm extending from the hoist, and a winch coupled to the end of the hoist arm. In some embodiments, a plurality of temporary braces are positioned longitudinally along the frame for transport. A boom lift or other machine is coupled to the temporary brace cart via the bracket and pulls the temporary brace cart to the desired location. Once at position, a cable may extend from the winch to a temporary brace. The winch may then be actuated so as to raise one end of the temporary brace, where it may be held until secured to the wall and ground by a worker.

In some embodiments, the hoist may comprise one or more extensions, allowing the overall height of the hoist to be customized according to the needs of the user. Additionally, the hoist may be stowed longitudinally along the frame when not in use. In some embodiments, the hoist may be raised and lowered to position using a generator. The same generator may also power the winch, although in some embodiments different power sources may be used.

### BRIEF DESCRIPTION OF THE DRAWINGS

FIG. 1 illustrates a right, side perspective view of a temporary brace cart;

FIG. 2 illustrates a left, side perspective view of a temporary brace cart;

FIG. 3 illustrates a temporary brace cart hauling temporary braces and being pulled by a boom lift (boom lift simplified here for ease of viewing);

FIG. 4 illustrates a left, side perspective view of a temporary brace cart with the hoist in a stowed configuration;

FIG. 5 illustrates a detailed, underside view of a bracket of a temporary brace cart for coupling to a boom lift or other machine;

FIG. 6 illustrates a temporary brace cart positioned at a jobsite with a plurality of temporary braces on the frame and one temporary brace being hoisted and held in position by the hoist;

FIG. 7 illustrates a detailed, exploded view of a hoist, hoist arm, winch, and gripper of a temporary brace cart; and

FIG. 8 illustrates a detailed, side perspective view of the coupling site of the hoist to the frame of the temporary brace cart.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there is a need for an improved system and method that facilitates the transportation and positioning of temporary wall braces, reducing the physical burden on workers, enhancing safety, and streamlining the construction process, ultimately leading to increased efficiency and reduced costs on the jobsite. The temporary brace cart disclosed herein solves these and other problems.

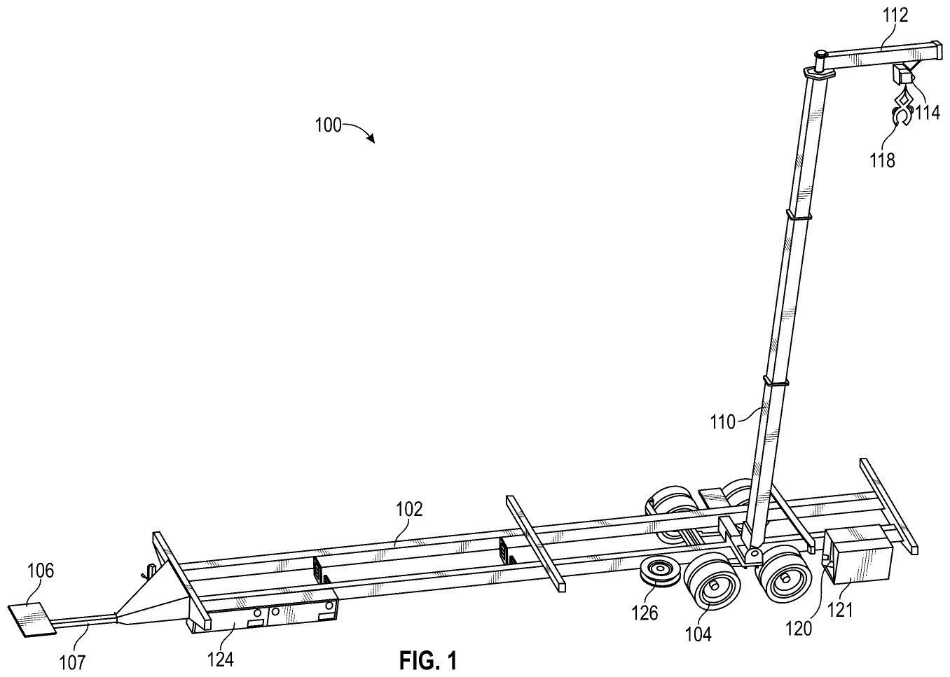

Referring to FIGS. 1-6, in some embodiments, a temporary brace cart 100 comprises a frame 102, a plurality of wheels 104 for moving the frame 102, a bracket 106 for coupling the frame 102 to a vehicle 108 (e.g., boom lift or other or other vehicle capable of towing the temporary brace cart 100 on a job site), a hoist 110 extending vertically from the frame 102, a hoist arm 112 extending substantially perpendicularly from the hoist 110, and a winch 114 coupled to the distal end of the hoist arm 112. While a bracket 106 is shown and described, it will be appreciated that a standard hitch mechanism or other coupling may be used to tow the temporary brace cart 100.

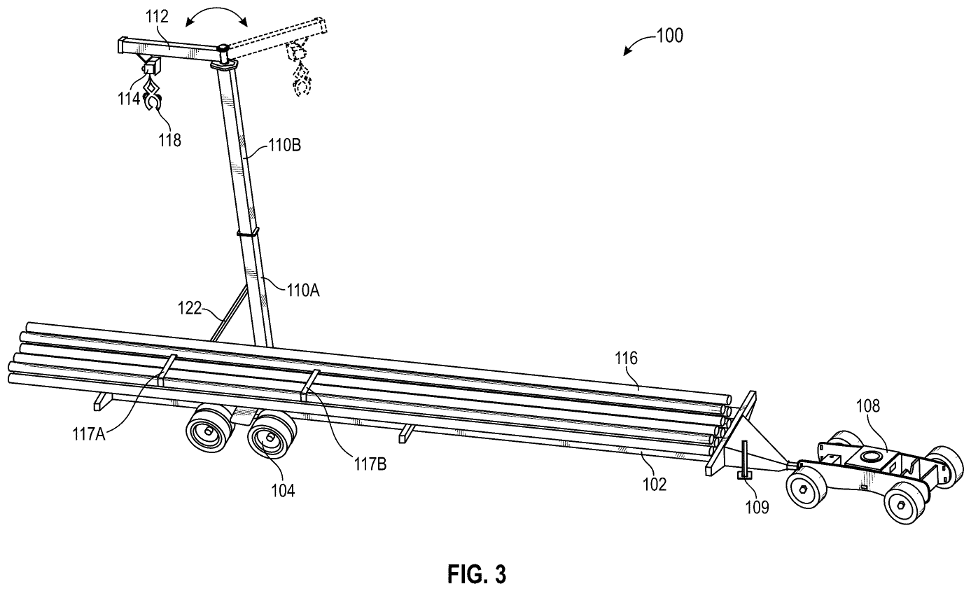

The hoist arm 112 may swivel on the hoist 110, allowing a user to position a brace gripper 118 where desired in relation to a temporary brace 116 (FIG. 3) resting longitudinally on the frame 102. The winch 114 may be powered by a generator 120 or other power source (e.g., batteries, the tow vehicle, etc.) and controlled via a user interface, which may include buttons, switches, joysticks, screens, lights, keyboards, and/or other input/output mechanisms. The user interface may be located near the generator 120, such as on the generator housing 121. In some embodiments, a handheld user device may be used as the input/output. For example, the winch 114 may be wirelessly controlled via a controller and transceiver, allowing a user to control the state of the winch 114 using a remote (e.g., IR, Bluetooth®, Wi-Fi, etc.) or smart device (e.g., smartphone/tablet). Additionally, the temporary brace cart 100 may comprise one or more sensors for detecting various statuses and reporting to a user. For example, sensors may be used to detect the winch 114 status and strain, generator status, battery status, etc.

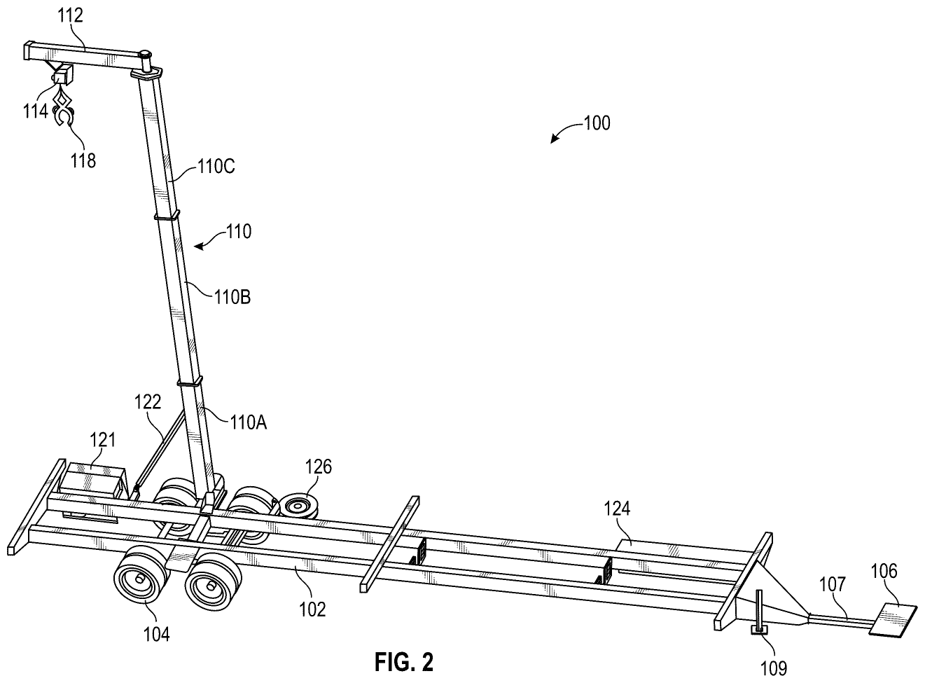

As best seen in FIGS. 2-4, the hoist 110 may comprise a plurality of sections 110A-C, allowing the user to customize the overall height of the hoist 110, depending on the wall braces 116 being hoisted. The sections 110A-C may be telescopic with one another and secured using locking pins or other mechanisms, or may bolt together using flanges, or any other mechanism capable of securely coupling the sections to on another that provides for enough structural integrity so as to not bend or otherwise fail at the coupling points. FIG. 2 shows three sections 11A-C for a first height, while FIG. 3 shows two sections 110A-B for a second height that is shorter than the first height. It will be appreciated that the sections 110A-C may vary in length, thereby varying the overall height of the hoist 110. Further, it will be understood that sections are not required, and that the hoist 110 may be of singular construction.

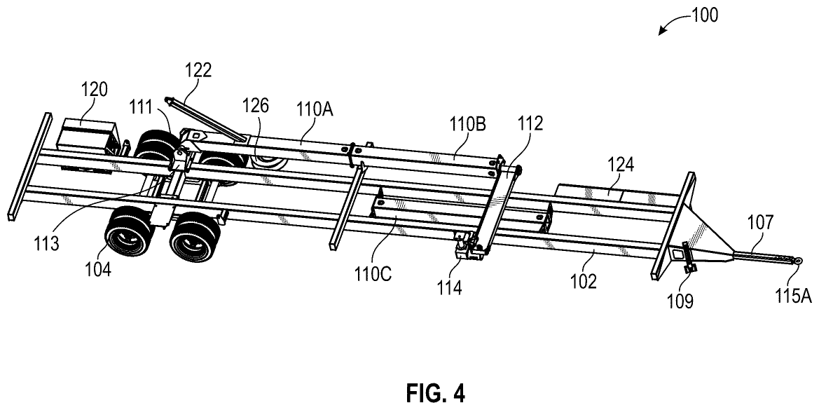

Additionally, referring to FIG. 4, in some embodiments, the hoist 110 and hoist sections 110A-C may be stowed longitudinally along the frame 102 when not in use, such as when transporting to and from a jobsite. In some embodiments, the hoist 110 may be pivotably coupled to the frame 102 via a pivot pin 111 and hoist bracket 113. A locking pin, locking ratchet, or other locking mechanism may be used to prevent unwanted pivoting of the hoist 110 on the pivot pin 111. In some embodiments, the hoist 110 may be raised and lowered to position (i.e., pivoting on pivot pin 111) using power from the generator 120 and a second winch system, or other motor, on the frame 102. For example, a motor and one or more gears may be used to pivot the hoist 110 in relation to the frame 102. The same generator 120 may also power the winch 114 on the hoist arm 112, although in some embodiments different power sources may be used, including battery power with one or more batteries on the brace cart 100. In some embodiments, the hoist 110 may be manually pivoted such as by using a telehandler, crane, or other machinery capable of lifting the hoist 110 from a horizontal position to a vertical position.

As shown, a hoist brace 122 may be coupled to the first hoist section 110A so as to support the hoist 110 when positioned vertically and add structural integrity when hoisting temporary braces 116, the hoist brace 122 being removably couplable to the frame 102 (e.g., locking pin, nut and bolt, etc.). It will be appreciated that the hoist brace 122 may be pivotably coupled to the first hoist section 110A so as to lay flat thereon, or removably couplable thereto (e.g., bolts, locking pins, etc.), when not being used.

The temporary brace cart 100 may further comprise one or more storage boxes 124 coupled to the frame 102 where a user may store tools, straps, batteries, or any other item useful at a jobsite. Additionally, the temporary braces 116 may be secured to the frame 102 using one or more straps, which may be coiled on a spindle 126. The spindle 126 may be manually or electronically actuated by a user to thereby tighten the straps on the braces 116 and to store the strap when not in use.

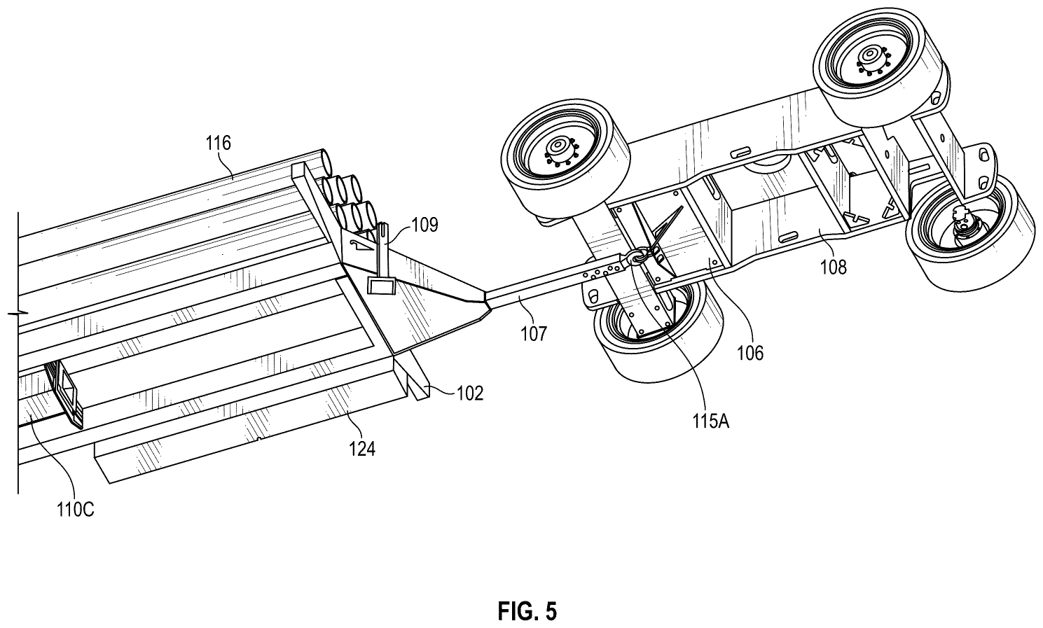

As shown in FIG. 3, in some embodiments, a plurality of temporary braces 116 are positioned longitudinally along the frame 102 for transport. One or more supporting brackets 117A-B may be positioned between rows of temporary braces 116 to prevent them from rolling. It will be understood that each supporting bracket 117A-B may comprise a plurality of brace receiving apertures to support individual braces 116 without the braces 116 capable of rolling. Additionally, as shown (and will be further described later herein), the hoist arm 112 may rotate on the hoist 110, as selected by a user, to grasp a desired temporary brace 116. The frame 102 is coupled to a tongue 107, which may be supported off the ground or other surface with a jack stand 109. As best shown in FIG. 5, the vehicle 108 or other machine is coupled to the cart 100 via a bracket 106 (or other coupling mechanism) and pulls the cart 100 to the desired location. The bracket 106 may be bolted to the vehicle 108, with the tongue 107 comprising a tow ring 115A that is removably couplable to the bracket 106 via a quick-release ring 115B, carabiner, or other connection ring/link on the bracket 106. As a result, the brace cart 100 may be quickly coupled or decoupled from the vehicle 108. However, as previously noted, other tow mechanisms may also be used, such as tow ball and trailer coupler.

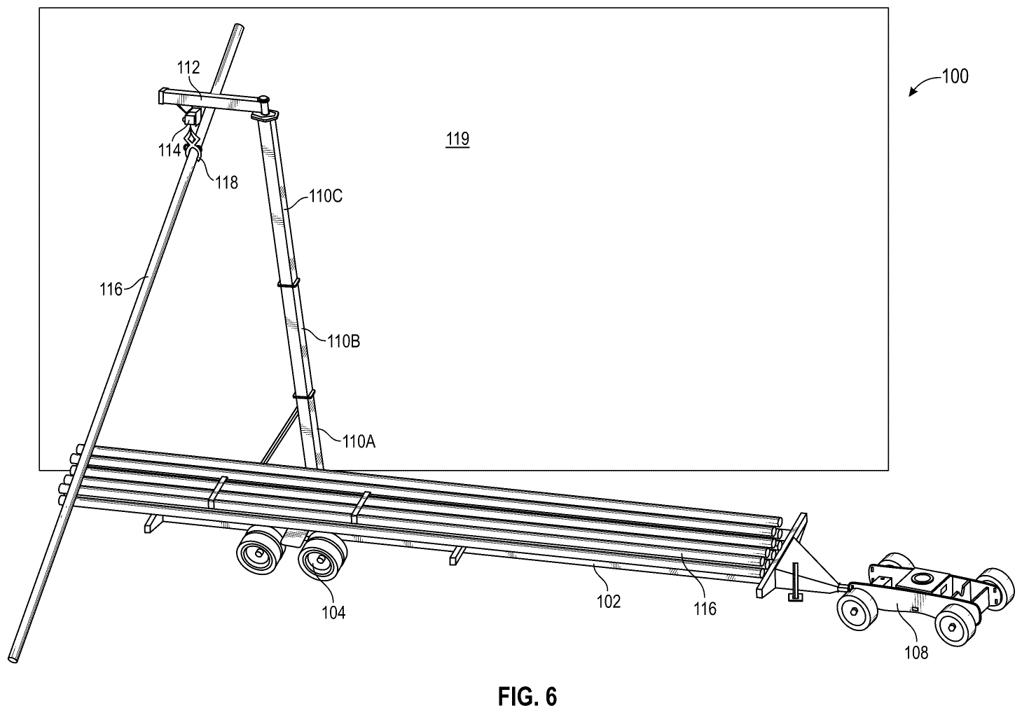

Referring to FIG. 6, once the brace cart 100 is towed or otherwise maneuvered to the desired location, the winch 114 may be rotated to the desired position and the gripper 118 may be lowered, via the winch 114, to grasp a temporary brace 116. Once a selected brace 116 is grasped by the gripper 118, the winch 114 may then be actuated so as to raise a first end of the temporary brace 116, where it may be held by the gripper 118 until the first end is secured to the wall 119 and a second end of the temporary brace 116 is secured to the ground by a worker.

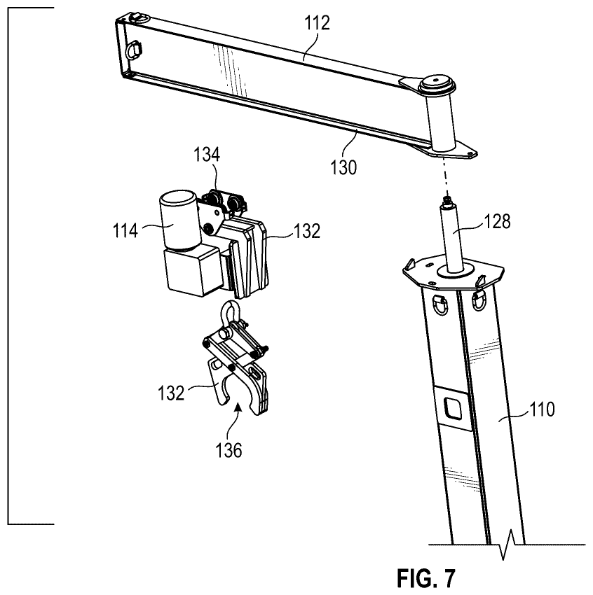

Referring to FIG. 7, a detailed, exploded view of the hoist arm 112, winch 114, gripper 118, hoist 110, and other components are shown. In particular, the hoist arm 112 may rotate or pivot on a pivot rod 128, which may comprise bearings to allow smooth rotation of the hoist arm 112 in relation to the hoist 110. Further, the hoist arm 112 may be configured as an I-beam, having lower flanges 130. The lower flanges 130 function as a track along with the winch 114 may travel, the winch 114 comprising or otherwise coupled to a trolley 132 comprising a plurality of wheels 134 that ride on the lower flanges 130 of the hoist arm 112. Although not visible in this FIG., it will be understood that there is at least one wheel 134 on a first side of the hoist arm 112 and at least one second wheel on the opposite side of the hoist arm 112, thereby preventing the trolley 132 from disconnecting from the hoist arm 112 unless disassembled by a user. This allows the winch 114 to move along the length of the hoist arm 112, allowing a user to position the winch 114 in their desired location.

Additionally, the gripper 118 may be a scissor grip, as shown, which does not require additional power to control. In other words, when the gripper 118 is lowered to the braces 116, the scissor grip may be manually actuated by a user to place a brace 116 within the mouth 136 of the gripper 118. As the winch 114 begins to lift the gripper 118, the scissor grip actuates due to the tension and weight of the brace 116, causing the gripper 118 to maintain a firm grip on the brace 116. As a result, no additional mechanisms are needed to control the gripper 118. However, it will be appreciated that other grippers may be used, including those that are manually actuated or motorized. Additionally, while scissor grips are shown, it will be appreciated that other styles of grippers may be used that facilitate lifting of a cylindrical brace 116.

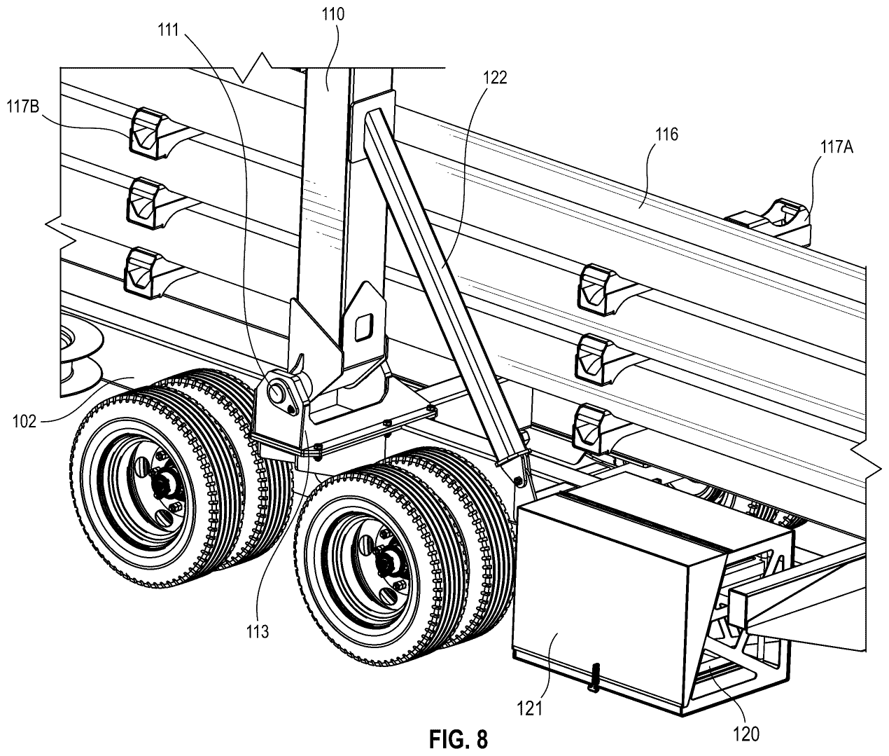

FIG. 8 illustrates a detailed view of the coupling of the hoist 110 to the frame 102. In particular, the hoist bracket 113 is coupled to the frame 102. The pivot pin 111 passes through the hoist bracket 113 and the base of the hoist 110, thereby allowing the hoist 110 to pivot on the pivot pin 111. The pivot pin 111 may include a locking mechanism to prevent the hoist 110 from pivoting unintendedly. Additionally, the hoist brace 122 couples to the frame 102 on a first end and the hoist 110 on a second end, thereby supporting the hoist 110 and adding structural integrity thereto. The hoist brace 122 may be coupled to the frame using bolts, locking pins, or other mechanisms. When coupled to the frame 102, the hoist 110 is also prevented from pivoting.

In some methods of use, the hoist 110 may be stowed on the frame 102 as shown in FIG. 4. A user may place a plurality of braces 116 thereon, interposing rows of braces 116 with one or more supporting bracket 117A-B. The braces 116 may then be secured using straps or other means. The brace cart 100 may then be coupled to a vehicle 108 for transportation to a worksite. Once positioned, the hoist 110 may be pivoted on the pivot pin 111 so that the hoist 110 is in a vertical position. It will be understood that prior to pivoting, the overall height of the hoist 110 may be selected by a user by adding one or more sections 110A-C. Once the hoist 110 is vertical, the hoist brace 122 may be secured to the frame 102, thereby preventing the hoist 110 from pivoting unintendedly.

A user may then lower the gripper 118 by actuating the winch 114. The winch 114 may be actuated using a remote, smartphone, or other handheld device, or may be controlled via a user input on the cart 100, such as a rocker switch (e.g., up, down, off). With the gripper 118 lowered, a user may manually rotate the hoist arm 112 by selectively pulling the gripper 118 in the desired direction. Once the desired location is achieved, the user places a brace 116 in the mouth 136 of the gripper 118. With the brace 116 in the gripper 118, a user may then actuate the winch 114 in the opposite direction, pulling the gripper 118 upwardly. As the gripper 118 ascends, it lifts the selected end of the brace 116 to which it is coupled, raising it to the desired height. One or more users may then secure the brace 116 to the wall on the upper end (the end hoisted by the gripper 118) and secures the lower end to the ground/surface. Once secured, the winch 114 may be actuated to lower the gripper 118, which releases the tension on the scissor grip and allows a user to remove the brace 116 from the mouth 136 of the gripper 118.

Accordingly, the temporary brace cart 100 disclosed herein solves the need for a system and method of more easily transporting and positioning temporary wall braces, overcoming limitations in the prior art.

It will be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A temporary brace cart, comprising:
a frame;
a plurality of wheels for moving the frame;
a hoist extending vertically from the frame;
a hoist arm extending horizontally from the top of the hoist; and
a winch coupled to the hoist arm, the winch comprising a gripper.

2. The temporary brace cart of claim 1, wherein the hoist comprises a plurality of sections.

3. The temporary brace cart of claim 1, wherein the hoist is pivotably coupled to the frame.

4. The temporary brace cart of claim 1, further comprising a hoist brace selectively couplable between the hoist and the frame.

5. The temporary brace cart of claim 1, further comprising a generator.

6. The temporary brace cart of claim 1, wherein the hoist arm is configured to rotate on the hoist.

7. The temporary brace cart of claim 1, wherein the winch is coupled to a trolley, wherein the trolley is configured to move along the length of the hoist arm.

8. The temporary brace cart of claim 1, further comprising one or more supporting brackets for interposing between rows of temporary braces.

9. The temporary brace cart of claim 1, further comprising a spindle for winding straps.

10. A temporary brace cart, comprising:
a frame;
a plurality of wheels for moving the frame;
a tongue extending from the frame, the tongue configured to couple to a vehicle;
a hoist pivotably coupled to the frame, the hoist comprising a plurality of removably couplable sections;
a hoist brace selectively coupled to the hoist and the frame;
a hoist arm extending horizontally from the top of the hoist; and
a winch coupled to the hoist arm, the winch comprising a gripper.

11. The temporary brace cart of claim 10, further comprising a generator.

12. The temporary brace cart of claim 10, wherein the hoist arm is configured to rotate on the hoist.

13. The temporary brace cart of claim 10, wherein the winch is coupled to a trolley, the trolley comprising a plurality of wheels, the wheels configured to move along the length of the hoist arm.

14. The temporary brace cart of claim 10, further comprising one or more supporting brackets for interposing between rows of temporary braces.

15. The temporary brace cart of claim 10, further comprising a spindle for winding straps.

16. A method of using a temporary brace cart to maneuver temporary braces, the method comprising:
loading a plurality of temporary braces onto the temporary brace cart;
towing the temporary brace cart to the desired location;
raising and securing a hoist in a vertical position;
actuating a winch coupled to a top end of the hoist to lower a gripper to the plurality of temporary braces;
securing a temporary brace from the plurality of temporary braces in the gripper; and
actuating the winch to raise the temporary brace from the temporary brace cart.

17. The method of claim 16, wherein once the hoist is in a vertical position, securing the hoist to a frame via a hoist brace.

18. The method of claim 16, further comprising adjusting the height of the hoist by adding or removing one or more sections.

19. The method of claim 16, wherein the winch is coupled to the hoist via a hoist arm, and wherein a user may pivot or rotate the hoist arm on the hoist to the desired position.

20. The method of claim 16, wherein the temporary brace cart is towed via a bracket coupled to a vehicle.
